(19) United States
(12) Patent Application Publication
(10) Pub. No.: US 2026/0208745 A1
(43) Pub. Date: Jul. 23, 2026

(54) MANAGEMENT APPARATUS

(71) Applicants: TOYOTA JIDOSHA KABUSHIKI KAISHA, Toyota-shi (JP); ADVICS CO., LTD, KARIYA-SHI (JP); J-QuAD DYNAMICS Inc., Tokyo (JP)

(72) Inventors: Yusuke KAMIYA, Toyota-shi (JP); Kazuki MIYAKE, Okazaki-shi (JP); Sotaro MURAMATSU, Tokyo (JP)

(21) Appl. No.: 19/430,565

(22) Filed: Dec. 23, 2025

(30) Foreign Application Priority Data
Jan. 23, 2025 (JP) 2025-010024

(51) Int. Cl. B60W 50/00; B60W 30/18

(52) U.S. Cl. CPC B60W 50/00; B60W 30/18109; B60W 2050/0027; B60W 2050/0091

(57) ABSTRACT

A management apparatus includes a processing circuit configured to execute arbitration processing when the processing circuit receives a plurality of requests and activate an actuator 40 based on a requested value of a request selected in the arbitration processing. When a low-priority request in which a low-priority flag indicating that the priority is lower than other requests is ON is included in the received requests, the processing circuit excludes the low-priority request from a target of arbitration in the arbitration processing when the low-priority request is a request realized without control of a brake. The processing circuit does not exclude the low-priority request from the target of arbitration in the arbitration processing when the low-priority request is a request realized by controlling the brake.

### CROSS-REFERENCE TO RELATED APPLICATION

This application claims priority to Japanese Patent Application No. 2025-010024 filed on Jan. 23, 2025. The disclosure of the above-identified application, including the specification, drawings, and claims, is incorporated by reference herein in its entirety.

### BACKGROUND

### 1. Technical Field

The present disclosure relates to a management apparatus.

### 2. Description of Related Art

A management apparatus is disclosed in Japanese Unexamined Patent Application Publication No. 2022-160174 (JP 2022-160174 A). When this management apparatus receives a request regarding the acceleration rate of a vehicle from an advanced driver assistance system (ADAS) application that realizes an autonomous driving function, the management apparatus controls a plurality of actuators based on the request. When the management apparatus receives requests from a plurality of ADAS applications, the management apparatus controls the actuators while selecting requests to be applied by arbitrating the requests.

When there are no requests with a low-priority flag set ON among the received requests, the management apparatus performs the arbitration based on a predetermined selection criterion. The management apparatus performs arbitration based on a criterion of selecting the request having the smallest presented acceleration rate among the requests as the predetermined selection criterion, for example.

When there is a request with the low-priority flag set ON among the received requests, the management apparatus excludes the request with the low-priority flag set ON from the target of arbitration.

### SUMMARY

When a request with the low-priority flag not set ON is received when an actuator is activated based on a request with the low-priority flag set ON, the request with the low-priority flag set ON is excluded from the arbitration. Therefore, the management apparatus starts the activation of the actuator based on the request with the low-priority flag not set ON. For example, as described above, when arbitration is performed based on a criterion of selecting the request having the smallest presented value among a plurality of requests and there is one request that is the target of arbitration, the value of the request is selected as is without any limitations. When the request has a large acceleration rate, the acceleration rate of the vehicle suddenly becomes large, and hence a user who is driving may feel uncomfortable.

A management apparatus of the present disclosure includes a processing circuit configured to receive a request from a plurality of applications as a request regarding an acceleration rate of a vehicle and activate an actuator based on the request. Each of the applications is configured to output either a lower limit system request that functions as a lower limit value of the acceleration rate or an upper limit system request that functions as an upper limit value of the acceleration rate. The processing circuit is configured to execute arbitration processing including first arbitration processing of selecting a maximum value out of a requested value in the lower limit system request and a requested value of an acceleration rate requested by an operation that requests acceleration by a user of the vehicle as a first arbitration value and second arbitration processing of selecting a minimum value out of a requested value in the upper limit system request, a requested value of an acceleration rate requested by an operation that requests deceleration by the user of the vehicle, and the first arbitration value as a second arbitration value in accordance with reception of a plurality of requests from the applications, activate the actuator based on the second arbitration value after the arbitration processing, exclude the low-priority request from a target of arbitration in the arbitration processing when the low-priority request is a request realized without control of a brake, and not exclude the low-priority request from the target of arbitration in the arbitration processing when the low-priority request is a request realized by controlling the brake, when the requests include a low-priority request in which a low-priority flag indicating that a priority is lower than another request is set to ON.

The management apparatus is capable of reducing a risk of making a user uncomfortable when two requests, that is, a request with the low-priority flag set ON and a request with the low-priority flag not set ON are input.

The processing circuit may be configured to not exclude, when the low-priority request included in the requests is the request realized without the control of the brake and is the upper limit system request, the low-priority request from the target of arbitration in the arbitration processing.

The processing circuit may be configured to receive a plurality of requests including the low-priority request that is the request realized by controlling the brake and that is the upper limit system request from the applications and execute, when a requested value of the low-priority request is not selected as the second arbitration value in the arbitration processing, the arbitration processing by considering the requested value of the low-priority request as a value having a magnitude equivalent to an acceleration rate at a time of engine braking while the low-priority request is the request realized by controlling the brake from the arbitration processing onward.

The processing circuit may be configured to receive a plurality of requests including the low-priority request that is the request realized by controlling the brake and that is the lower limit system request from the applications and exclude, when a requested value of the low-priority request is not selected as the second arbitration value in the arbitration processing, the low-priority request from the target of arbitration in the arbitration processing from the arbitration processing onward.

The management apparatus may further include a storage apparatus configured to store the low-priority request excluded from the target of arbitration in the arbitration processing in storage apparatus. The processing circuit may be configured to exclude the stored low-priority request from the target of arbitration in the arbitration processing from the arbitration processing onward.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration of a vehicle including a management apparatus of one embodiment;

FIG. 2 is a sequence diagram showing an aspect of communication executed in a vehicle control system in FIG. 1;

FIG. 3 is a diagram showing an aspect of arbitration processing executed by the management apparatus in FIG. 1;

FIG. 4 is a time chart showing transition of a requested acceleration rate arbitrated by a management apparatus of a comparative example that has received a lower limit system request;

FIG. 5 is a time chart showing the transition of the requested acceleration rate arbitrated by the management apparatus of the comparative example that has received an upper limit system request;

FIG. 6 is a time chart showing the transition of the requested acceleration rate arbitrated by the management apparatus of the comparative example that has received the upper limit system request;

FIG. 7 is a flowchart showing a flow of a series of processing executed by the management apparatus in FIG. 1;

FIG. 8 is a flowchart showing a flow of a series of processing executed by the management apparatus shown in FIG. 1 when a low-priority request loses in arbitration in the arbitration processing;

FIG. 9 is a time chart showing the transition of the requested acceleration rate in a first case arbitrated by the management apparatus in FIG. 1;

FIG. 10 is a time chart showing the transition of the requested acceleration rate in a second case arbitrated by the management apparatus in FIG. 1;

FIG. 11 is a time chart showing the transition of the requested acceleration rate in a third case arbitrated by the management apparatus in FIG. 1; and

FIG. 12 is a time chart showing the transition of the requested acceleration rate in a fourth case arbitrated by the management apparatus in FIG. 1.

### DETAILED DESCRIPTION OF EMBODIMENTS

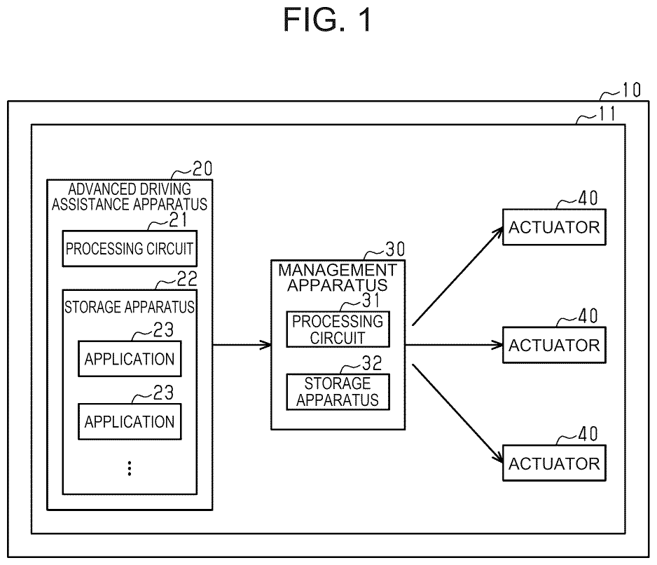

One embodiment of a management apparatus is described below with reference to FIG. 1 to FIG. 12.

### Configuration of Vehicle 10

As shown in FIG. 1, a vehicle 10 includes a vehicle control system 11. In the vehicle 10, the vehicle control system 11 realizes autonomous driving functions such as autonomous driving and autonomous parking.

As shown in FIG. 1, the vehicle control system 11 includes an advanced driving assistance apparatus 20. The advanced driving assistance apparatus 20 includes a storage apparatus 22 that stores a program therein, and a processing circuit 21 that realizes various processing by executing the program stored in the storage apparatus 22. The processing circuit 21 may include one processor or two or more processors.

The storage apparatus 22 stores a plurality of applications 23 therein. The applications 23 are advanced driver assistance system (ADAS) applications that realize the autonomous driving functions. The applications 23 include an ADAS application that realizes a preceding-vehicle following traveling function of traveling by following a vehicle traveling ahead while maintaining a certain distance from the vehicle such as adaptive cruise control (ACC), for example. The applications 23 include an ADAS application that realizes collision avoidance assistance such as pre-crash safety (PCS), for example.

As shown in FIG. 1, the vehicle control system 11 includes a management apparatus 30. The management apparatus 30 includes a storage apparatus 32 that stores a program therein, and a processing circuit 31 that realizes various processing by executing the program stored in the storage apparatus 32. The processing circuit 31 may include one processor or two or more processors. The processing circuit 31 may store a processing result and the like in the storage apparatus 32.

As shown in FIG. 1, the vehicle control system 11 includes a plurality of actuators 40. The actuators 40 include a brake that generates a braking force in the vehicle 10 such as a hydraulic brake or an electric parking brake. The actuators 40 include apparatuses relating to a power train that can generate a driving force in the vehicle 10 such as an engine and a transmission.

In the vehicle control system 11, each application 23 outputs a request regarding an acceleration rate of the vehicle 10 in order to realize its function. In the vehicle control system 11, the advanced driving assistance apparatus 20 transmits the request output from each application 23 to the management apparatus 30. In the vehicle control system 11, the management apparatus 30 activates the actuators 40 based on the request received from the advanced driving assistance apparatus 20.

### Aspect of Communication in Vehicle Control System 11

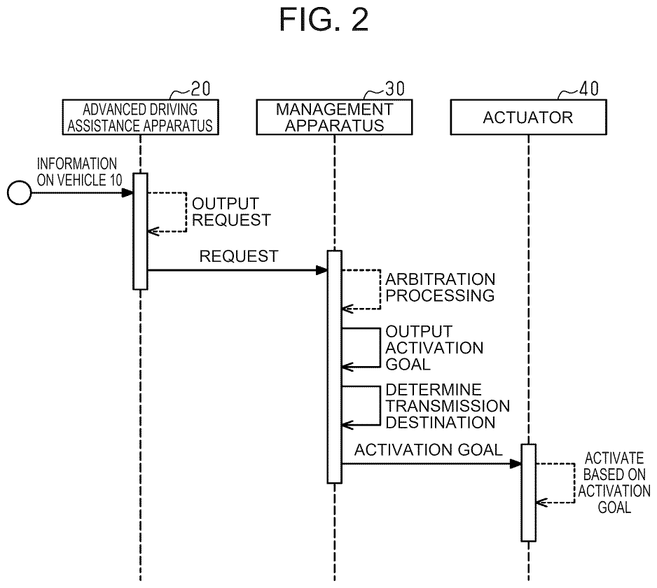

FIG. 2 shows an aspect of communication executed by the advanced driving assistance apparatus 20, the management apparatus 30, and the actuator 40 in the vehicle control system 11.

As shown in an upper stage in FIG. 2, in the communication in the vehicle control system 11, the advanced driving assistance apparatus 20 first receives information relating to the vehicle 10. The information relating to the vehicle 10 is an output value of a sensor included in the vehicle 10, for example. The information relating to the vehicle 10 is information acquired by image recognition of an image acquired by a camera included in the vehicle 10, for example. The information relating to the vehicle 10 is information on a speed of the vehicle 10, for example. The information relating to the vehicle 10 is information indicating a state of the power train of the vehicle 10, for example. The information relating to the vehicle 10 is information indicating a state of the brake of the vehicle 10, for example.

As shown in the upper stage in FIG. 2, in the advanced driving assistance apparatus 20, after each application 23 receives information relating to the vehicle 10, the application 23 outputs a request regarding the acceleration rate of the vehicle 10 based on the received information in order to realize its function. The request output by each application 23 includes a request that accelerates the vehicle 10 and a request that decelerates the vehicle 10.

As shown in the upper stage in FIG. 2, after each application 23 outputs a request, the advanced driving assistance apparatus 20 transmits the output request to the management apparatus 30. When the applications 23 each output a request, the advanced driving assistance apparatus 20 transmits each of the requests to the management apparatus 30.

As shown in a middle stage in FIG. 2, the management apparatus 30 executes arbitration processing after the management apparatus 30 receives a request. Although described later, the request received by the management apparatus 30 includes a request output by the applications 23 and a request caused by the operation of a user of the vehicle 10. The arbitration processing is processing of selecting requests to be employed in order to activate the actuators 40 among the received requests. Details of the arbitration processing are described later.

As shown in the middle stage in FIG. 2, after the arbitration processing is executed, the management apparatus 30 outputs an activation goal based on the request selected in the arbitration processing. The activation goal is an output amount from the actuator 40 that is necessary in order to realize the request selected in the arbitration processing. For example, the activation goal is an amount of torque that needs to be output by the actuator 40 in order to realize the acceleration rate indicated by the requested value in the request.

As shown in the middle stage in FIG. 2, after the management apparatus 30 outputs an activation goal, the management apparatus 30 determines a transmission destination of the activation goal. At this time, the management apparatus 30 determines the actuator 40 that is necessary in order to realize the output activation goal as the transmission destination of the activation goal. For example, when the management apparatus 30 needs to activate the brake in order to realize the activation goal, the management apparatus 30 determines the brake as the transmission destination of the activation goal. For example, when the management apparatus 30 needs to activate an apparatus relating to the power train in order to realize the activation goal, the management apparatus 30 determines the apparatus as the transmission destination of the activation goal.

As shown in a lower stage in FIG. 2, after the management apparatus 30 determines the transmission destination of the activation goal, the management apparatus 30 transmits information indicating the activation goal toward the actuator 40. At this time, the management apparatus 30 transmits the information indicating the activation goal to the actuator 40 determined as the transmission destination of the activation goal among the actuators 40.

As shown in the lower stage in FIG. 2, the actuator 40 that has received the information indicating the activation goal is activated based on the activation goal indicated by the receive information. As above, the vehicle control system 11 realizes the functions of the applications 23 in the vehicle 10.

### Aspect of Arbitration Processing

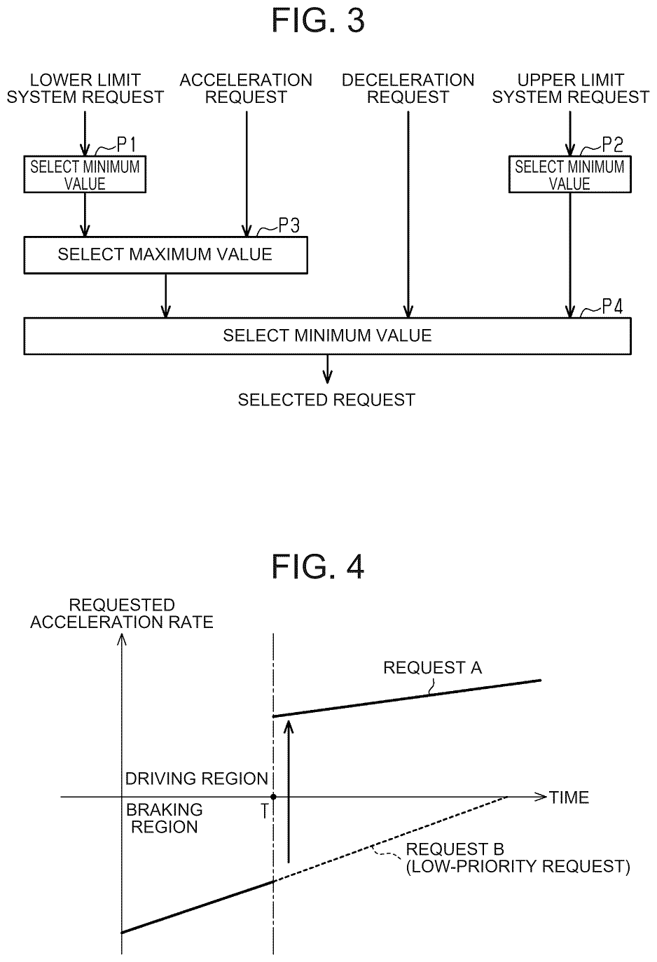

FIG. 3 shows an aspect in which a request is selected in the arbitration processing executed by the management apparatus 30.

Each application 23 outputs either a lower limit system request or an upper limit system request as the request.

The lower limit system request is a request that works as a lower limit value of the acceleration rate in the vehicle 10. For example, the application 23 that realizes ACC outputs a lower limit system request.

The upper limit system request is a request that works as an upper limit value of the acceleration rate in the vehicle 10. For example, the application 23 that realizes PCS outputs an upper limit system request.

The management apparatus 30 may receive a request caused by the operation of the user besides the requests output by the applications 23. The management apparatus 30 may receive an acceleration request or a deceleration request as a request caused by the operation of the user.

The acceleration request is a request regarding the acceleration rate of the vehicle 10 caused by an operation that requests acceleration by the user. The operation that requests acceleration is an operation of stepping on an accelerator of the vehicle 10, for example.

The deceleration request is a request regarding the acceleration rate of the vehicle 10 caused by an operation that requests deceleration by the user. The operation that requests deceleration is an operation of stepping on the brake of the vehicle 10, for example.

As shown in FIG. 3, the arbitration processing includes four stages of processing, that is, P1 to P4.

In processing in the stage of P1, the management apparatus 30 selects a request from the received lower limit system request. When the management apparatus 30 receives a plurality of lower limit system requests, the management apparatus 30 selects a request with the minimum requested value among the lower limit system requests in the processing in the stage of P1. When the management apparatus 30 receives only one lower limit system request, the management apparatus 30 selects the received lower limit system request in the processing in the stage of P1. When the management apparatus 30 does not receive a lower limit system request, the management apparatus 30 does not execute the processing in the stage of P1 in the arbitration processing. The lower limit system request selected in the processing in the stage of P1 is hereinafter referred to as a selected lower limit system request.

In processing in the stage of P2, the management apparatus 30 selects a request from the received upper limit system request. When the management apparatus 30 receives a plurality of upper limit system requests, the management apparatus 30 selects a request with the minimum requested value among the upper limit system requests in the processing in the stage of P2. When the management apparatus 30 receives only one upper limit system request, the management apparatus 30 selects the received upper limit system request in the processing in the stage of P2. When the management apparatus 30 does not receive an upper limit system request, the management apparatus 30 does not execute the processing in the stage of P2 in the arbitration processing. The upper limit system request selected in the processing in the stage of P2 is hereinafter referred to as a selected upper limit system request.

In processing in the stage of P3, the management apparatus 30 selects a request from a selected lower limit system request and an acceleration request. When the management apparatus 30 receives both of a lower limit system request and an acceleration request, the management apparatus 30 selects a request with the maximum requested value among a selected lower limit system request and the acceleration request in the processing in the stage of P3. When the management apparatus 30 receives a lower limit system request and does not receive an acceleration request, the management apparatus 30 selects a selected lower limit system request in the processing in the stage of P3. When the management apparatus 30 receives an acceleration request and does not receive a lower limit system request, the management apparatus 30 selects the acceleration request in the processing in the stage of P3. When the management apparatus 30 receives neither a lower limit system request nor an acceleration request, the management apparatus 30 does not execute the processing in the stage of P3 in the arbitration processing.

The processing in the stage of P3 in the arbitration processing is hereinafter referred to as first arbitration processing. The request selected in the first arbitration processing is hereinafter referred to as a first arbitration request. A requested value of the request selected in the first arbitration processing is a first arbitration value. In other words, the management apparatus 30 selects the maximum value among the requested value in the selected lower limit system request and the requested value in the acceleration request as the first arbitration value in the first arbitration processing.

In processing in the stage of P4, the management apparatus 30 selects a request from the first arbitration request, the selected upper limit system request, and the deceleration request. When the management apparatus 30 executes the processing in the stages of P2 and P3 and receives a deceleration request, a request with the minimum requested value among the selected upper limit system request, the first arbitration request, and the deceleration request is selected in the processing in the stage of P4.

When the management apparatus 30 executes the processing in the stages of P2 and P3 and does not receive a deceleration request, a request with the minimum requested value among the selected upper limit system request and the first arbitration request is selected in the processing in the stage of P4. When the management apparatus 30 executes the processing in the stage of P2, does not execute the processing in the stage of P3, and receives a deceleration request, a request with the minimum requested value among the selected upper limit system request and the deceleration request is selected in the processing in the stage of P4. When the management apparatus 30 does not execute the processing in the stage of P2, executes the processing in the stage of P3, and receives a deceleration request, a request with the minimum requested value among the first arbitration request and the deceleration request is selected in the processing in the stage of P4. When there is only one request out of the first arbitration request, the selected upper limit system request, and the deceleration request, the management apparatus 30 selects that one request in the processing in the stage of P4.

The processing in the stage of P4 in the arbitration processing is hereinafter referred to as second arbitration processing. The request selected in the second arbitration processing is hereinafter referred to as a second arbitration request. A requested value of the request selected in the second arbitration processing is a second arbitration value. In other words, the management apparatus 30 selects the minimum value among the requested value in the selected upper limit system request, the requested value in the deceleration request, and the first arbitration value as the second arbitration value in the second arbitration processing. The management apparatus 30 activates the actuator 40 based on the second arbitration value.

### Overview of Low-Priority Request

The management apparatus 30 may receive a request with the low-priority flag set ON. The low-priority flag in an ON state indicates that the priority is lower than other requests. When the necessity of realizing a request generated by each application 23 decreases, the application 23 sets the low-priority flag to ON for the request until the transmission of the request to the management apparatus 30 stops. Examples of such a situation include a case in which it has become unnecessary to output the request from the application 23 but the value of the request is gradually reduced and is degenerated because the acceleration rate of the vehicle 10 suddenly changes when the output of the request is suddenly stopped. When each application 23 degenerates a request, the application 23 sets the low-priority flag associated with the request to ON. The request with the low-priority flag set ON is hereinafter referred to as a low-priority request.

With reference to FIG. 4 to FIG. 6, a case of arbitration processing by a management apparatus of a comparative example is described.

### Description of Time Chart Showing Transition of Requested Acceleration Rate

In FIG. 4 to FIG. 6 and FIG. 9 to FIG. 12, transition of the requested acceleration rate that is the requested value of the request received by the management apparatus 30 is shown by time charts.

In the time charts, the requested acceleration rate is divided into a driving region and a braking region based on the boundary of an acceleration rate equivalent to the lower limit value of the driving force that can be generated by the vehicle 10 at that time. The acceleration rate equivalent to the lower limit value of the driving force that can be generated by the vehicle 10 at that time is hereinafter referred to as a lower limit equivalent G. The lower limit equivalent G is an acceleration rate realized in the vehicle 10 when neither the accelerator nor the brake is operated, that is, when so-called engine braking is being applied.

The driving region is a region in which the requested acceleration rate is larger than the lower limit equivalent G. When the requested acceleration rate in the request is on the driving region side, the request is requesting that the vehicle 10 be accelerated more than when the engine braking is being applied.

The request in which the requested acceleration rate is on the driving region side is realized as a result of the activation of the actuators 40 such as the engine and not by the brake. In other words, the request in which requested acceleration rate is on the driving region side is a request realized without the control of the brake.

The braking region is a region in which the requested acceleration rate is smaller than the lower limit equivalent G. When the requested acceleration rate in the request is on the braking region side, the request is requesting that the vehicle 10 be decelerated more than when the engine braking is being applied.

The request in which the requested acceleration rate is on the braking region side is realized as a result of the activation of the brake that is the actuator 40. In other words, the request in which requested acceleration rate is on the braking region side is a request realized by controlling the brake.

The acceleration request is caused by the operation that requests acceleration by the user, and hence the requested acceleration rate is on the driving region side. The deceleration request is caused by the operation that requests deceleration by the user, and hence the requested acceleration rate is on the braking region side.

In FIG. 4 to FIG. 6 and FIG. 9 to FIG. 12, requests selected by the management apparatus 30 as the second arbitration requests are indicated by solid lines. In FIG. 4 to FIG. 6 and FIG. 9 to FIG. 12, requests that have not been selected by the management apparatus 30 as the second arbitration requests are indicated by broken lines.

### First Comparative Example

FIG. 4 shows one example of the transition of the requested acceleration rate arbitrated by the management apparatus of the comparative example. In FIG. 4, the management apparatus of the comparative example receives two requests, that is, a request A and a request B. The request A and the request B are lower limit system requests transmitted from the applications 23. In a first comparative example shown in FIG. 4, the request B is a low-priority request.

As shown in FIG. 4, when the low-priority request is a lower limit system request, the requested acceleration rate of the low-priority request gradually approaches the lower limit equivalent G. The transmission of the low-priority request toward the management apparatus 30 is stopped from the time that the requested acceleration rate reaches the lower limit equivalent G onward.

In FIG. 4, the management apparatus of the comparative example only receives the request B until a time point of T. The management apparatus of the comparative example selects the request B as the second arbitration request in the arbitration processing until the time point of T.

The management apparatus of the comparative example receives two requests, that is, the request A and the request B from the applications 23 from the time point of T onward. When the management apparatus of the comparative example receives a plurality of requests from the applications 23, the management apparatus performs the following. When a low-priority request is included in the received requests, the management apparatus excludes the low-priority request from the target of arbitration in the arbitration processing. Therefore, from the time point of T onward, the management apparatus of the comparative example excludes the request B from the target of arbitration and selects the request A as the second arbitration request.

The requested acceleration rate of the request A is in the driving region, and hence the request A is a request realized without the control of the brake. Meanwhile, the requested acceleration rate of the request B is in the braking region, and hence the request B is a request realized by controlling the brake.

In the first comparative example shown in FIG. 4, at the time point of T, the management apparatus of the comparative example switches the activation of the actuators 40 from being based on the requested acceleration rate of the request B with the control of the brake to being based on the requested acceleration rate of the request A without the control of the brake. In this case, the brake is released, and hence there is a risk of making the user who is driving uncomfortable.

### Second Comparative Example

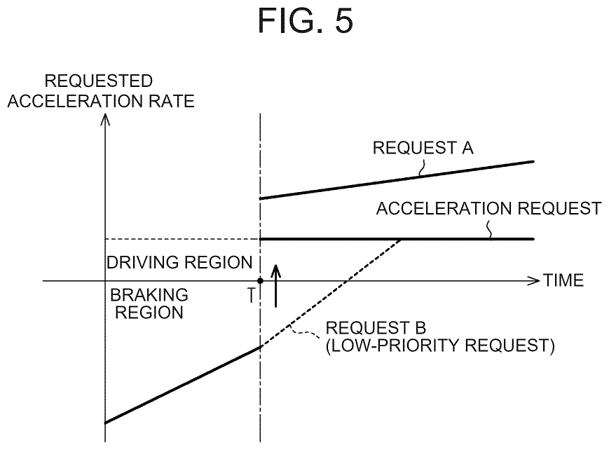

FIG. 5 shows a second comparative example of the aspect in which the management apparatus of the comparative example receives a request. The second comparative example is a comparative example different from that in FIG. 4. In the second comparative example shown in FIG. 5, the management apparatus of the comparative example receives three requests, that is, a request A, a request B, and an acceleration request. The request A and the request B are requests transmitted from the applications 23.

In the second comparative example shown in FIG. 5, the request B is an upper limit system request and is a low-priority request. As shown in FIG. 5, when the low-priority request is an upper limit system request, the requested acceleration rate of the low-priority request gradually approaches the requested acceleration rate requested by the operation of the user. In FIG. 5, an acceleration request is transmitted, and hence the requested acceleration rate of the request B gradually approaches the requested acceleration rate of the acceleration request. In the vehicle control system 11, when a deceleration request is transmitted instead of an acceleration request, the requested acceleration rate of the request B gradually approaches the requested acceleration rate of the deceleration request. The transmission of the low-priority request that is the upper limit system request toward the management apparatus 30 is stopped from the time that the requested acceleration rate reaches the requested acceleration rate requested by the operation of the user onward.

In FIG. 5, the management apparatus of the comparative example receives the acceleration request and the request B until the time point of T. As described above, when the management apparatus of the comparative example receives a plurality of requests from the applications 23, the management apparatus excludes low-priority requests from the target of arbitration. The acceleration request is a request caused by the operation of the user. In other words, until the time point of T, the management apparatus of the comparative example only receives the request B from the application 23, and hence the request B is not excluded from the target of arbitration.

The request B has a smaller requested acceleration rate than the acceleration request until the time point of T. Therefore, the management apparatus of the comparative example selects the request B as the second arbitration request in the arbitration processing until the time point of T.

In FIG. 5, from the time point of T onward, the management apparatus of the comparative example receives the request A that is a request transmitted from the application 23 in addition to the request B and the acceleration request. In other words, the management apparatus of the comparative example receives a plurality of requests from the applications 23 from the time point of T onward. In this case, the management apparatus of the comparative example excludes the request B that is a low-priority request from the target of arbitration.

When the request A is a lower limit system request, the management apparatus of the comparative example selects the request A as the second arbitration request by performing the arbitration processing shown in FIG. 3 by excluding the request B from the target of arbitration from the time point of T onward. When the request A is an upper limit system request, the management apparatus of the comparative example selects the acceleration request as the second arbitration request by performing the arbitration processing shown in FIG. 3 by excluding the request B from the target of arbitration from the time point of T onward.

The requested acceleration rates of the request A and the acceleration request are in the driving region, and hence the request A and the acceleration request are requests realized without the control of the brake. Meanwhile, the requested acceleration rate of the request B is in the braking region, and hence the request B is a request realized by controlling the brake.

In the second comparative example shown in FIG. 5, at the time point of T, the management apparatus of the comparative example switches the activation of the actuators 40 from being based on the requested acceleration rate of the request B with the control of the brake to being based on the requested acceleration rate of the request A or the acceleration request without the control of the brake. In this case, as with FIG. 4, the brake is released, and hence there is a risk of making the user who is driving uncomfortable.

### Third Comparative Example

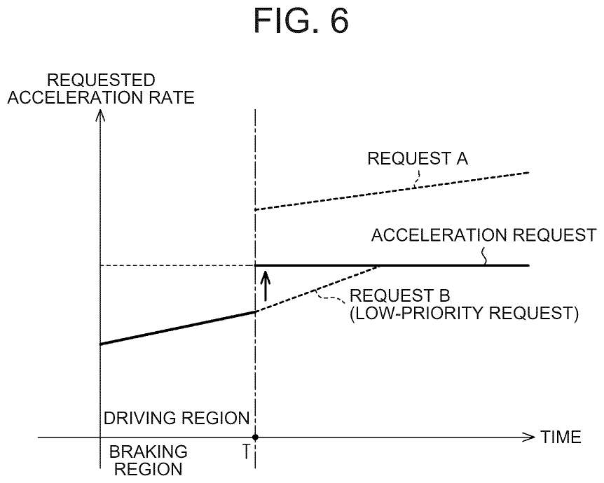

FIG. 6 shows a third comparative example of the aspect in which the management apparatus of the comparative example receives a request. The third comparative example is a comparative example different from those in FIG. 4 and FIG. 5.

In the third comparative example shown in FIG. 6, the management apparatus of the comparative example receives three requests, that is, a request A, a request B, and an acceleration request. The request A and the request B are upper limit system requests transmitted from the applications 23.

In the third comparative example shown in FIG. 6, the request B is a low-priority request. In FIG. 6, an acceleration request is transmitted, and hence the requested acceleration rate of the request B gradually approaches the requested acceleration rate of the acceleration request as with the case of FIG. 5. As with the case of FIG. 5, the transmission of the request B toward the management apparatus of the comparative example is stopped from the time that the requested acceleration rate reaches the requested acceleration rate requested by the operation of the user onward.

In FIG. 6, the management apparatus 30 receives the acceleration request and the request B until a time point of T. In other words, until the time point of T, the management apparatus of the comparative example only receives the request B from the application 23, and hence the request B is not excluded from the target of arbitration as with the case of FIG. 5.

The request B has a smaller requested acceleration rate than the acceleration request until the time point of T. Therefore, the management apparatus of the comparative example selects the request B as the second arbitration request in the arbitration processing until the time point of T.

In FIG. 6, from the time point of T onward, the management apparatus of the comparative example receives the request A that is a request transmitted from the application 23 in addition to the request B and the acceleration request. In other words, the management apparatus 30 receives a plurality of requests from the applications 23 from the time point of T onward. In this case, the management apparatus of the comparative example excludes the request B that is a low-priority request from the target of arbitration.

In FIG. 6, the request A is an upper limit system request, and hence the management apparatus of the comparative example selects the acceleration request as the second arbitration request by performing the arbitration processing shown in FIG. 3 by excluding the request B from the target of arbitration from the time point of T onward.

The requested acceleration rates of the request A, the request B, and the acceleration request are in the driving region, and hence those three requests are requests realized without the control of the brake. In the case shown in FIG. 6, at the time point of T, the management apparatus of the comparative example switches the activation of the actuators 40 from being based on the requested acceleration rate of the request B to being based on the requested acceleration rate of the acceleration request. In this case, the requested acceleration rate to be applied is switched. When such the requested acceleration rate is applied as is, there is a risk that the vehicle 10 may suddenly accelerate. As a result, there is a risk of making the user who is driving uncomfortable.

As described with reference to FIG. 4 to FIG. 6, in the arbitration processing in the aspects of those comparative examples, there is a risk of making the user uncomfortable in certain situations. The management apparatus 30 according to this embodiment reduces the risk of occurrence of an uncomfortable feeling as that described with reference to FIG. 4 to FIG. 6 by exercising ingenuity in the arbitration processing.

### Aspect of Processing Executed by Management Apparatus 30

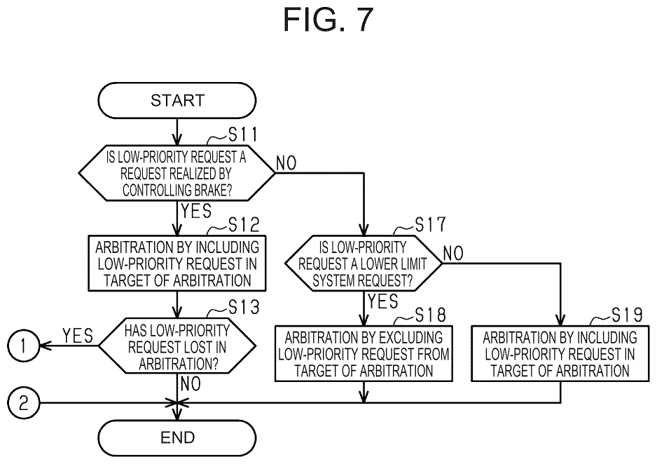

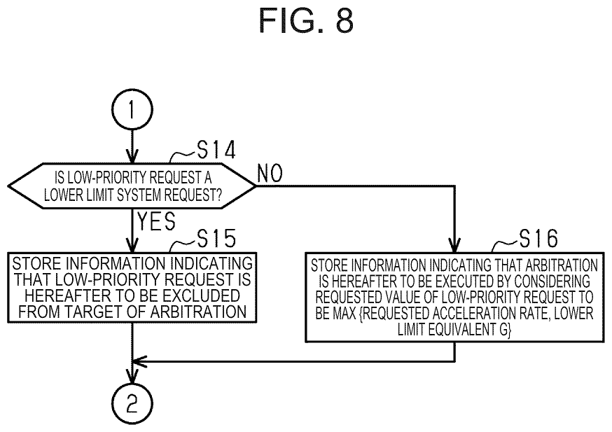

FIG. 7 and FIG. 8 show an aspect of a series of processing executed by the processing circuit 31 of the management apparatus 30. When the processing circuit 31 receives both of a low-priority request and a request with the low-priority flag not set ON, the processing circuit 31 executes the processing shown in FIG. 7 and FIG. 8.

As shown in FIG. 7, when the processing circuit 31 receives both of a low-priority request and a request with the low-priority flag not set ON, the processing circuit 31 first executes processing in step S11. In the processing in step S11, the processing circuit 31 determines whether the received low-priority request is a request realized by controlling the brake.

In the processing in step S11, when the processing circuit 31 determines that the received low-priority request is a request realized by controlling the brake (step S11: YES), the processing circuit 31 causes the processing to proceed to step S12.

In the processing in step S12, the processing circuit 31 executes the arbitration processing by including the low-priority request in the target of arbitration. Then, the processing circuit 31 executes processing in step S13.

In the processing in step S13, the processing circuit 31 determines whether the low-priority request has lost in arbitration as a result of the arbitration processing. The expression of “a request loses in arbitration” means that the requested value in the request is not selected as the second arbitration value in the arbitration processing.

When the processing circuit 31 determines that the low-priority request has not lost in arbitration as a result of the arbitration processing in the processing in step S13 (step S13: NO), the series of processing shown in FIG. 7 and FIG. 8 are ended. Meanwhile, when the processing circuit 31 determines that the low-priority request has lost in arbitration as a result of the arbitration processing in the processing in step S13 (step S13: YES), the processing circuit 31 causes the processing to proceed to step S14 shown in FIG. 8.

In processing in step S14, the processing circuit 31 determines whether the low-priority request that has lost in arbitration is a lower limit system request. When the processing circuit 31 determines that the low-priority request that has lost in arbitration is a lower limit system request in the processing in step S14 (step S14: YES), the processing circuit 31 causes the processing to proceed to step S15. In the processing in step S15, the processing circuit 31 stores information indicating that this low-priority request is thereafter to be excluded from the target of arbitration in the arbitration processing.

After the processing circuit 31 executes the processing in step S15, the processing circuit 31 ends the series of processing shown in FIG. 7 and FIG. 8. The processing circuit 31 that has executed the processing in step S15 does not execute the series of processing shown in FIG. 7 and FIG. 8 thereafter even when the processing circuit 31 receives both of this low-priority request and a request with the low-priority flag not set ON. Instead, the processing circuit 31 executes the arbitration processing by excluding this low-priority request from the target of arbitration.

When the processing circuit 31 determines that the low-priority request that has lost in arbitration is not a lower limit system request in the processing in step S14 (step S14: NO), the processing circuit 31 causes the processing to proceed to step S16. In other words, when the low-priority request that has lost in arbitration is an upper limit system request in the processing in step S14, the processing circuit 31 causes the processing to proceed to step S16. In the processing in step S16, the processing circuit 31 stores information indicating that the arbitration processing is thereafter to be executed by considering the requested value of this low-priority request to be the larger one of the requested acceleration rate of the low-priority request and the lower limit equivalent G.

After the processing circuit 31 executes the processing in step S16, the processing circuit 31 ends the series of processing shown in FIG. 7 and FIG. 8. The processing circuit 31 that has executed the processing in step S16 does not execute the processing shown in FIG. 7 and FIG. 8 thereafter when the processing circuit 31 receives both of this low-priority request and a request with the low-priority flag not set ON. Instead, the processing circuit 31 executes the arbitration processing by considering that the requested value of this low-priority request is the value shown in step S16.

In the processing in step S11, when the processing circuit 31 determines that the received low-priority request is not a request realized by controlling the brake (step S11: NO), the processing circuit 31 causes the processing to proceed to step S17. In other words, when the received low-priority request is a request realized without the control of the brake, the processing circuit 31 causes the processing to proceed to step S17.

In processing in step S17, the processing circuit 31 determines whether the received low-priority request is a lower limit system request.

When the processing circuit 31 determines that the received low-priority request is a lower limit system request in the processing in step S17 (step S17: YES), the processing circuit 31 causes the processing to proceed to step S18.

In the processing in step S18, the processing circuit 31 executes the arbitration processing by excluding this low-priority request from the target of arbitration. In other words, in step S18, the processing circuit 31 executes the arbitration processing in an aspect similar to that of the management apparatus of the comparative example described above. The processing circuit 31 that has executed the processing in step S18 then ends the series of processing shown in FIG. 7 and FIG. 8.

When the processing circuit 31 determines that the received low-priority request is not a lower limit system request in the processing in step S17 (step S17: YES), the processing circuit 31 causes the processing to proceed to step S19. In other words, when the received low-priority request is an upper limit system request, the processing circuit 31 causes the processing to proceed to step S19.

In processing in step S19, the processing circuit 31 executes the arbitration processing by including this low-priority request in the target of arbitration. The processing circuit 31 that has executed the processing in step S19 then ends the series of processing shown in FIG. 7 and FIG. 8.

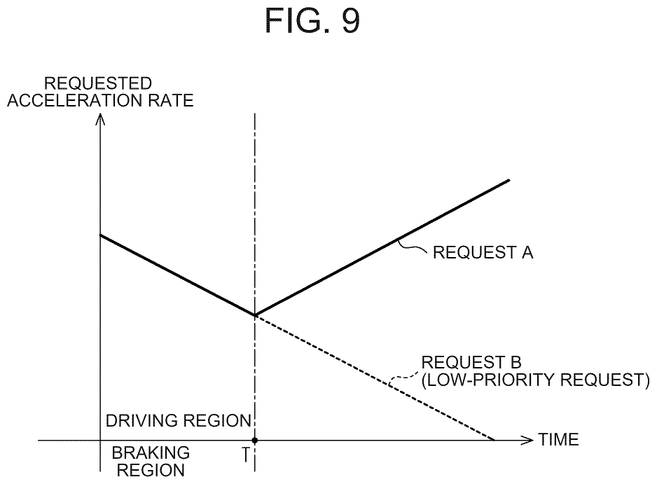

With reference to a case shown in FIG. 9 to FIG. 12, how the arbitration is performed when the series of processing shown in FIG. 7 and FIG. 8 are executed is described below.

### First Case

FIG. 9 shows a first case that is one example of an aspect in which the management apparatus 30 receives requests. In FIG. 9, the management apparatus 30 receives two requests, that is, a request A and a request B. The request A and the request B are lower limit system requests transmitted from the applications 23. In FIG. 9, the request B is a low-priority request.

In FIG. 9, the management apparatus 30 only receives the request B until a time point of T. The management apparatus 30 selects the request B as the second arbitration request in the arbitration processing until the time point of T.

In FIG. 9, the management apparatus 30 receives the request A in addition to the request B from the time point of T onward. In other words, the management apparatus 30 receives both of a low-priority request and a request with the low-priority flag not set ON from the time point of T. Therefore, the management apparatus 30 executes the processing shown in FIG. 7 and FIG. 8 each time the management apparatus 30 receives the request A and the request B from the time point of T onward.

The management apparatus 30 first executes the processing in step S11 when the management apparatus 30 executes the processing shown in FIG. 7 and FIG. 8. In the case shown in FIG. 9, the request B is a request realized without the control of the brake. Therefore, the management apparatus 30 causes the processing to proceed to step S17 after the processing in step S11.

In FIG. 9, the request B is a lower limit system request. Therefore, the management apparatus 30 executes the processing in step S18 after the management apparatus 30 executes the processing in step S17. In the processing in step S18, the management apparatus 30 executes the arbitration processing by excluding the low-priority request from the target of arbitration. Therefore, in FIG. 9, after the time point of T, the management apparatus 30 selects the request A as the second arbitration request.

As above, when the management apparatus 30 receives a plurality of requests including a low-priority request from the applications 23, the management apparatus 30 excludes the low-priority request from the target of arbitration in the arbitration processing when the low-priority request is a lower limit system request realized without the control of the brake. In other words, when the management apparatus 30 receives a request that is a low-priority request and that is a lower limit system request, the management apparatus 30 executes the arbitration processing in an aspect similar to that of the management apparatus of the comparative example when the request is a request realized without the control of the brake.

### Second Case

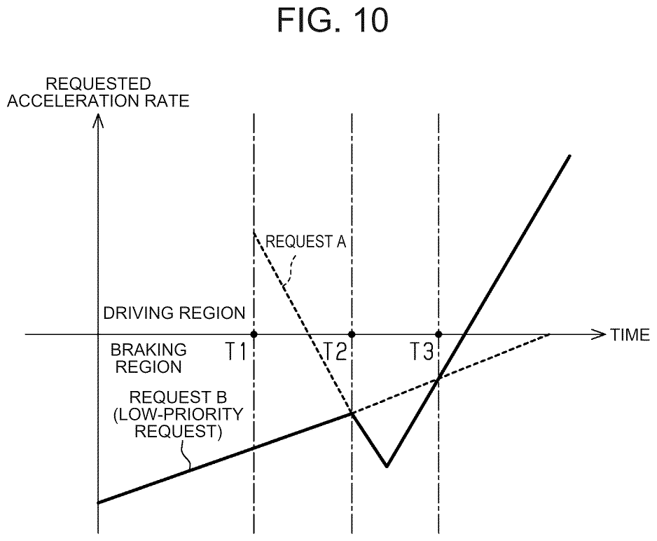

FIG. 10 shows a second case of the aspect in which the management apparatus 30 receives requests. The second case is different from the case in FIG. 9. In FIG. 10, the management apparatus 30 receives two requests, that is, a request A and a request B. As with the case of FIG. 4, the request A and the request B are lower limit system requests transmitted from the applications 23. As with the case of FIG. 4, the request B is a low-priority request in the second case shown in FIG. 10.

In FIG. 10, the management apparatus 30 only receives the request B until a time point of T1. The management apparatus 30 selects the request B as the second arbitration request in the arbitration processing until the time point of T1.

In FIG. 10, the management apparatus 30 receives the request A in addition to the request B from the time point of T1 onward. In other words, the management apparatus 30 receives both of a low-priority request and a request with the low-priority flag not set ON from the time point of T1. Therefore, the management apparatus 30 executes the processing shown in FIG. 7 and FIG. 8 each time the management apparatus 30 receives the request A and the request B from the time point of T1 onward.

The result of the processing during a period of time differs between a period of time from the time point of T1 to a time point of T2 and a period of time from the time point of T2 to a time point of T3. First, the result of the processing during the period of time from the time point of T1 to the time point of T2 is described.

The management apparatus 30 first executes the processing in step S11 when the management apparatus 30 executes the processing shown in FIG. 7 and FIG. 8. In the case shown in FIG. 10, the request B is a request realized by controlling the brake. Therefore, the management apparatus 30 causes the processing to proceed to step S12 after the processing in step S11.

In the processing in step S12, the management apparatus 30 executes the arbitration processing by including the request B in the target of arbitration. As shown in FIG. 10, during the period of time from the time point of T1 to the time point of T2, the requested acceleration rate of the request B is smaller than the requested acceleration rate of the request A. Therefore, during the period of time from the time point of T1 to the time point of T2, the management apparatus 30 selects the request B as the second arbitration request after the arbitration processing shown in FIG. 3.

The management apparatus 30 executes the processing in step S13 after the management apparatus 30 executes the processing in step S12. The request B does not lose in arbitration in the arbitration processing during the period of time from the time point of T1 to the time point of T2. Therefore, during the period of time from the time point of T1 to the time point of T2, the management apparatus 30 ends the series of processing shown in FIG. 7 and FIG. 8 after the management apparatus 30 executes the processing in step S13.

As above, even when the management apparatus 30 receives a plurality of requests including a low-priority request from the applications 23, the management apparatus 30 does not exclude the low-priority request from the target of arbitration in the arbitration processing when the low-priority request is a request realized by controlling the brake. As a result, in the case of FIG. 10, the management apparatus 30 inhibits the occurrence of a situation in which the brake is released, for example, as shown in FIG. 4.

The management apparatus 30 executes the processing in step S11 and the processing in step S12 even when the management apparatus 30 executes the processing shown in FIG. 7 and FIG. 8 during the period of time from the time point of T2 to the time point of T3.

As shown in FIG. 10, during the period of time from the time point of T2 to the time point of T3, the requested acceleration rate of the request B becomes larger than the requested acceleration rate of the request A. In other words, the request B loses in arbitration when the management apparatus 30 executes the processing in step S12 during the period of time from the time point of T2 to the time point of T3. The request B is a lower limit system request. Therefore, the management apparatus 30 executes the processing in step S15 after the processing in step S13 and the processing in step S14 when the series of processing shown in FIG. 7 and FIG. 8 are executed during the period of time from the time point of T2 to the time point of T3.

The management apparatus 30 that has executed the processing in step S15 thereafter executes the arbitration processing by excluding the request B from the target of arbitration without executing the processing shown in FIG. 7 and FIG. 8 even when management apparatus 30 receives the request A and the request B. Therefore, in FIG. 10, the request B becomes larger than the request A again from the time point of T3 but the request A does not lose in arbitration.

### Third Case

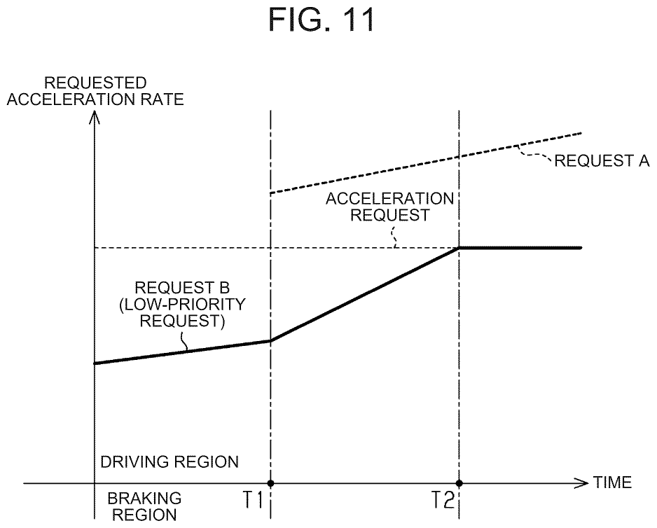

FIG. 11 shows a third case of the aspect in which the management apparatus 30 receives requests. The third case is different from the cases in FIG. 9 and FIG. 10. In FIG. 11, the management apparatus 30 receives three requests, that is, a request A, a request B, and an acceleration request. In FIG. 11, the request A and the request B are upper limit system requests transmitted from the applications 23 as with the case of FIG. 6. In FIG. 11, the request B is a low-priority request as with the case of FIG. 6.

In the third case shown in FIG. 11, the management apparatus 30 receives the request B and the acceleration request until a time point of T1. As shown in FIG. 11, in the period of time until the time point of T1, the request B has a smaller requested acceleration rate than the acceleration request. The management apparatus 30 selects the request B as the second arbitration request in the arbitration processing until the time point of T1.

In FIG. 11, the management apparatus 30 receives the request A in addition to the request B and the acceleration request from the time point of T1 onward. In other words, the management apparatus 30 receives both of a low-priority request and a request with the low-priority flag not set ON during a period of time from the time point of T1 to a time point of T2. Therefore, the management apparatus 30 executes the processing shown in FIG. 7 and FIG. 8 each time the management apparatus 30 receives the request A and the request B during the period of time from the time point of T1 to the time point of T2.

The management apparatus 30 first executes the processing in step S11 when the management apparatus 30 executes the processing shown in FIG. 7 and FIG. 8. In the case shown in FIG. 11, the request B is a request realized without the control of the brake. Therefore, the management apparatus 30 causes the processing to proceed to step S17 after the processing in step S11.

In FIG. 11, the request B is a lower limit system request. Therefore, the management apparatus 30 executes the processing in step S19 after the management apparatus 30 executes the processing in step S17. In the processing in step S19, the management apparatus 30 executes the arbitration processing by including the request B in the target of arbitration. The requested acceleration rate of the request B is smaller than the requested acceleration rates of the request A and the acceleration request. Therefore, in FIG. 11, the management apparatus 30 selects the request B as the second arbitration request during a period of time from the time point of T1 to the time point of T2.

As above, when the management apparatus 30 receives a plurality of requests including a low-priority request from the applications 23, the management apparatus 30 does not exclude a low-priority request from the target of arbitration in the arbitration processing when the low-priority request is an upper limit system request even when the request is a request realized without the control of the brake. As a result, in FIG. 11, the management apparatus 30 inhibits the occurrence of a situation in which the vehicle 10 accelerates, for example, as shown in FIG. 6.

As described above, when the low-priority request is an upper limit system request, the requested acceleration rate of the low-priority request gradually approaches the requested acceleration rate requested by the operation of the user. The requested acceleration rate of the request B becomes the same as the requested acceleration rate of the acceleration request at the time point of T2. The transmission of the request B toward the management apparatus 30 is stopped when the request B reaches the requested acceleration rate in the acceleration request and thereafter.

The requested acceleration rate of the acceleration request is smaller than the requested acceleration rate of the request A from the time point of T2 onward. Therefore, the management apparatus 30 selects the acceleration request as the second arbitration request in the arbitration processing from the time point of T2 onward.

### Fourth Case

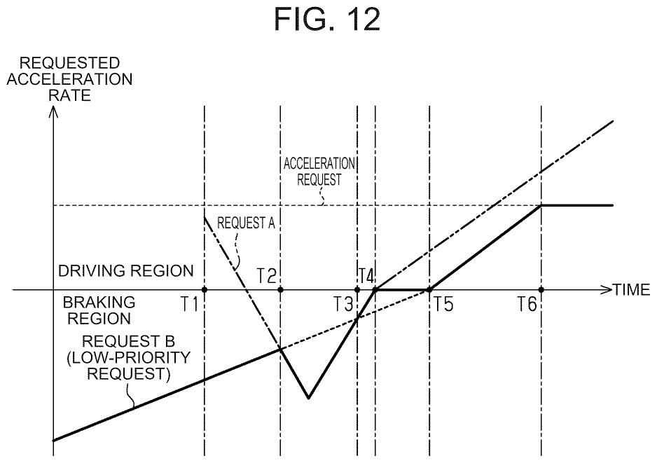

FIG. 12 shows a fourth case of the aspect in which the management apparatus 30 receives requests. The fourth case is different from the cases in FIG. 9 to FIG. 11. In FIG. 12, the management apparatus 30 receives three requests, that is, a request A, a request B, and an acceleration request. As with the case of FIG. 5, the request B is an upper limit system request transmitted from the application 23 and is a low-priority request. As with the request B, the request A is also an upper limit system request transmitted from the application 23. In FIG. 12, the request A is indicated by a two-dot-dash line in the period of time in which the request A is not selected as the second arbitration request.

In the fourth case shown in FIG. 12, the management apparatus 30 receives the request B and the acceleration request until a time point of T1. As shown in FIG. 12, in a period of time until the time point of T1, the request B has a smaller requested acceleration rate than the acceleration request. The management apparatus 30 selects the request B as the second arbitration request in the arbitration processing until the time point of T1.

In FIG. 12, the management apparatus 30 receives the request A in addition to the request B and the acceleration request from the time point of T1 onward. In other words, the management apparatus 30 receives both of a low-priority request and a request with the low-priority flag not set ON from the time point of T1. Therefore, the management apparatus 30 executes the processing shown in FIG. 7 and FIG. 8 each time the management apparatus 30 receives the request A and the request B from the time point of T1 onward.

The result of the processing during a period of time differs between a period of time from the time point of T1 to a time point of T2 and a period of time from T2 to a time point of T3. First, the result of the processing during the period of time from the time point of T1 to the time point of T2 is described.

The management apparatus 30 first executes the processing in step S11 when the management apparatus 30 executes the processing shown in FIG. 7 and FIG. 8. In the case shown in FIG. 12, the request B is a request realized by controlling the brake. Therefore, the management apparatus 30 causes the processing to proceed to step S12 after the processing in step S11.

In the processing in step S12, the management apparatus 30 executes the arbitration processing by including the request B in the target of arbitration. As shown in FIG. 12, during the period of time from the time point of T1 to the time point of T2, the requested acceleration rate of the request B is smaller than the requested acceleration rate of the request A. Therefore, during the period of time from the time point of T1 to the time point of T2, the management apparatus 30 selects the request B as the second arbitration request after the arbitration processing shown in FIG. 3.

The management apparatus 30 executes the processing in step S13 after the management apparatus 30 executes the processing in step S12. The request B does not lose in arbitration in the arbitration processing during the period of time from the time point of T1 to the time point of T2. Therefore, during the period of time from the time point of T1 to the time point of T2, the management apparatus 30 ends the series of processing shown in FIG. 7 and FIG. 8 after the management apparatus 30 executes the processing in step S13.

As above, in the case of FIG. 12, the management apparatus 30 inhibits the occurrence of a situation in which the brake is released, for example, as shown in FIG. 5. Even when the request A shown in FIG. 12 is a lower limit system request, the arbitration processing is executed in accordance with the processing in step S12, and hence the management apparatus 30 selects the request B as the second arbitration request. Therefore, even when the request A shown in FIG. 12 is a lower limit system request, the management apparatus 30 can inhibit the occurrence of a situation in which the brake is released, for example, as shown in FIG. 5.

The management apparatus 30 executes the processing in step S11 and the processing in step S12 even when the management apparatus 30 executes the series of processing shown in FIG. 7 and FIG. 8 during the period of time from the time point of T2 to the time point of T3.

As shown in FIG. 12, during the period of time from the time point of T2 to the time point of T3, the requested acceleration rate of the request B becomes larger than the requested acceleration rate of the request A. In other words, the request B loses in arbitration when the management apparatus 30 executes the processing in step S12 during the period of time from the time point of T2 to the time point of T3. The request B is an upper limit system request. Therefore, the management apparatus 30 executes the processing in step S16 after the processing in step S13 and the processing in step S14 when the series of processing shown in FIG. 7 and FIG. 8 are executed after the time point of T2.

From the processing in step S16 onward, the management apparatus 30 does not execute the processing shown in FIG. 7 and FIG. 8 when the management apparatus 30 receives both of the request A and the request B. Instead, the management apparatus 30 executes the arbitration processing by considering that the requested value of the request B is the larger one of the requested acceleration rate of the request B and the lower limit equivalent G. In other words, the management apparatus 30 executes the arbitration processing by considering that the requested value of the request B that is a low-priority request has a magnitude equivalent to the acceleration rate at the time of engine braking while the request B is a request realized by controlling the brake.

In a period of time from the time point of T2 to a time point of T5, the requested acceleration rate of the request B is equal to or less than the lower limit equivalent G. Therefore, the management apparatus 30 executes the arbitration processing by considering that the requested value of the request B is the lower limit equivalent G when the management apparatus 30 receives three requests, that is, the request A, the request B, and the acceleration request in the period of time from the time point of T2 to the time point of T5.

In a period of time from the time point of T2 to a time point of T4, the requested acceleration rate of the request A is smaller than the lower limit equivalent G. Therefore, in the period of time from the time point of T2 to the time point of T4, the management apparatus 30 selects the request A as the second arbitration request through the arbitration processing.

In a period of time from the time point of T4 to the time point of T5, the requested acceleration rate of the request A is larger than the lower limit equivalent G. Therefore, in the period of time from the time point of T4 to the time point of T5, the management apparatus 30 selects the request B having the requested value that is considered to be the lower limit equivalent G as the second arbitration request through the arbitration processing.

In a period of time from the time point of T5 to a time point of T6, the requested acceleration rate of the request B is larger than the lower limit equivalent G. Therefore, the management apparatus 30 executes the arbitration processing by considering that the requested acceleration rate of the request B is the requested value of the request B as is when the management apparatus 30 receives three requests, that is, the request A, the request B, and the acceleration request in the period of time from the time point of T5 to the time point of T6.

When the management apparatus 30 has received an acceleration request, the low-priority request gradually becomes a request that is realized without the control of the brake as shown in FIG. 12. In the case as in FIG. 12, when the low-priority request becomes a request realized without the control of the brake, the following occurs. When the request is excluded from the target of arbitration as in FIG. 9, it is conceived that acceleration as that shown in FIG. 6 occurs as a result of the acceleration request being selected as the second arbitration request.

As with the case in FIG. 11, the management apparatus 30 does not exclude a low-priority request from the target of arbitration in the arbitration processing when the low-priority request is an upper limit system request even when the request is a request realized without the control of the brake in the case of FIG. 12 as well. The management apparatus 30 inhibits the occurrence of a situation in which the vehicle 10 accelerates, for example, as shown in FIG. 6 in the case of FIG. 12 as well.

In a period of time from the time point of T5 to the time point of T6, the requested acceleration rate of the request A is larger than the requested acceleration rate of the request B. Therefore, in the period of time from the time point of T5 to the time point of T6, the management apparatus 30 selects the request B as the second arbitration request through the arbitration processing.

The requested acceleration rate of the request B becomes the same as the requested acceleration rate of the acceleration request at the time point of T6. The transmission of the request B toward the management apparatus 30 is stopped from the time that the requested acceleration rate reaches the requested acceleration rate requested by the operation of the user onward.

The requested acceleration rate of the acceleration request is smaller than the requested acceleration rate of the request A from the time point of T6 onward. Therefore, the management apparatus 30 selects the acceleration request as the second arbitration request in the arbitration processing from the time point of T6 onward.

### Workings of Embodiment

The requests by the applications 23 include a request realized without the control of the brake and a request realized by controlling the brake. When a request with the low-priority flag not set ON is received while the actuators 40 are being activated based on a request with the low-priority flag set ON, the management apparatus 30 starts activation of the actuators 40 based on a request with the low-priority flag not set ON. At this time, when the low-priority request is a request realized by controlling the brake and the request with the low-priority flag not set ON is a request realized without the control of the brake, a control aspect of the vehicle 10 is switched from a control aspect with the control of the brake to a control aspect without the control of the brake. In this case, the brake is released, and there is a risk of making the user who is driving uncomfortable.

When the management apparatus 30 receives a request, the management apparatus 30 excludes the low-priority request from the target of arbitration on the condition that the request is realized without the control of the brake in addition to the low-priority flag being ON.

### Effects of Present Embodiment

The management apparatus 30 is capable of reducing a risk of making a user uncomfortable when two requests, that is, a request with the low-priority flag set ON and a request with the low-priority flag not set ON are input.

When the requests received from the applications 23 include a low-priority request and the low-priority request is a request realized without the control of the brake, the management apparatus 30 does not exclude the low-priority request from the target of arbitration in the arbitration processing when the low-priority request is an upper limit system request.

When a request with the low-priority flag not set ON is received while the actuators 40 are being activated based on a request with the low-priority flag set ON, the management apparatus 30 starts activation of the actuators 40 based on a request with the low-priority flag not set ON. At this time, when the low-priority request and the request with the low-priority flag not set ON are upper limit system requests, there is a risk that the acceleration of the vehicle 10 may occur and the user who is driving may feel uncomfortable depending on conditions.

The management apparatus 30 does not exclude a low-priority request from the target of arbitration when the low-priority request is an upper limit system request even when the request is a request realized without the control of the brake. As a result, the management apparatus 30 is capable of reducing the risk of making the user uncomfortable by the acceleration of the vehicle 10 when two requests, that is, a request with the low-priority flag set ON and a request with the low-priority flag not set ON are received.

When the management apparatus 30 receives a plurality of requests including the low-priority request that is the request realized by controlling the brake and that is the upper limit system request from the applications 23, the management apparatus 30 executes, when a requested value of the low-priority request is not selected as the second arbitration value in the arbitration processing, the arbitration processing by considering the requested value of the low-priority request as a value having a magnitude equivalent to an acceleration rate at the time of engine braking while the low-priority request is the request realized by controlling the brake from the arbitration processing onward.

While the requested value in the low-priority request is selected in the arbitration processing, a requested value in other control is not selected. Therefore, control that is to be originally prioritized cannot be executed. In other words, while the requested value in the low-priority request is being selected in the arbitration processing, there is a risk of inefficiency occurring in the control of the vehicle 10. Meanwhile, the upper limit system request is a request that limits the acceleration rate of the vehicle 10. Therefore, it is conceived that it is preferred to not exclude the upper limit system request from the target of arbitration in the arbitration processing even when the upper limit system request is a low-priority request especially while the upper limit system request is a request realized by controlling the brake.

In other words, the management apparatus 30 executes the arbitration processing by considering that the requested value of the low-priority request has a magnitude equivalent to the acceleration rate at the time of engine braking while the low-priority request is a request realized by controlling the brake from the time when the requested value of the low-priority request is not selected in the arbitration processing. As a result, when a request other than the low-priority request is a request realized by controlling the brake, the management apparatus 30 can select the request in the arbitration processing. Meanwhile, when a request other than the low-priority request is a request realized without the control of the brake, the management apparatus 30 can inhibit the acceleration of the vehicle 10 by selecting a low-priority request considered to be a value having a magnitude equivalent to the acceleration rate at the time of engine braking without selecting the request. As above, the management apparatus 30 can alleviate inefficiency of the control of the vehicle 10 while inhibiting the acceleration of the vehicle 10.

When the management apparatus 30 receives a plurality of requests including the low-priority request that is the request realized by controlling the brake and that is the lower limit system request from the applications 23, the management apparatus 30 excludes, when a requested value of the low-priority request is not selected as the second arbitration value in the arbitration processing, the low-priority request from the target of arbitration in the arbitration processing from the arbitration processing onward.

When the low-priority request is a request realized by controlling the brake, the management apparatus 30 does not exclude the low-priority request from the target of arbitration in the arbitration processing. However, while the requested value in the low-priority request is being selected in the arbitration processing, the requested value in other control to be originally prioritized is not selected. Therefore, there is a risk of inefficiency occurring in the control of the vehicle 10.

When the requested value in the low-priority request is not selected in the arbitration processing, there are no risks of the brake being released due to the low-priority request even when the low-priority request is not set to be the target of arbitration thereafter. The management apparatus 30 excludes the low-priority request that is a lower limit system request from the target of arbitration in the arbitration processing from the time when the requested value in the low-priority request is not selected in the arbitration processing. As a result, the management apparatus 30 can alleviate inefficiency of the control of the vehicle 10.

### Modifications

The above-described embodiment can be implemented with changes made thereto as follows. The above-described embodiment and the following modifications can be implemented in combination within such a range that no technical contradiction arises.

As shown in FIG. 11 and FIG. 12, the management apparatus 30 does not exclude a low-priority request from the target of arbitration in the arbitration processing when the low-priority request is an upper limit system request even when the request is a request realized without the control of the brake. It is also possible for the management apparatus 30 to exclude a low-priority request from the target of arbitration in the arbitration processing when the low-priority request is a request realized without the control of the brake and is an upper limit system request.

As shown in FIG. 12, after the low-priority request that is the upper limit system request has lost in arbitration, the management apparatus 30 executes the arbitration processing by considering that the requested value has a magnitude equivalent to the acceleration rate at the time of engine braking while the request is a request realized by controlling the brake. The aspect in which the management apparatus 30 executes the arbitration processing after the low-priority request that is the upper limit system request has lost in arbitration is not limited to the embodiment described above. For example, even when a low-priority request that is an upper limit system request is a request realized by controlling the brake after the low-priority request has lost in arbitration, the management apparatus 30 may execute the arbitration processing by handling the requested acceleration rate of the low-priority request to be the requested value as is. For example, the management apparatus 30 may exclude a low-priority request that is an upper limit system request from the target of arbitration after the low-priority request has lost in arbitration.

As shown in FIG. 10, the management apparatus 30 may exclude a low-priority request that is a lower limit system request from the target of arbitration after the low-priority request has lost in arbitration. The management apparatus 30 does not necessarily need to exclude the low-priority request that is the lower limit system request from the target of arbitration after the low-priority request has lost in arbitration.

The aspect of the arbitration processing is not limited to the aspect shown in FIG. 3. For example, in addition to the requests shown in FIG. 3, the management apparatus 30 may receive a request the requested value of which is an acceleration rate independent of the amount of operation of the user when the user loses driving ability.

What is claimed is:

1. A management apparatus comprising a processing circuit, the processing circuit being configured to receive a request from a plurality of applications as a request regarding an acceleration rate of a vehicle and activate an actuator based on the request, the applications each being configured to output either a lower limit system request that functions as a lower limit value of the acceleration rate or an upper limit system request that functions as an upper limit value of the acceleration rate, wherein the processing circuit is configured to:
execute arbitration processing including first arbitration processing of selecting a maximum value out of a requested value in the lower limit system request and a requested value of an acceleration rate requested by an operation that requests acceleration by a user of the vehicle as a first arbitration value and second arbitration processing of selecting a minimum value out of a requested value in the upper limit system request, a requested value of an acceleration rate requested by an operation that requests deceleration by the user of the vehicle, and the first arbitration value as a second arbitration value in accordance with reception of a plurality of requests from the applications;
activate the actuator based on the second arbitration value after the arbitration processing; and
exclude a low-priority request from a target of arbitration in the arbitration processing when the low-priority request is a request realized without control of a brake and not exclude the low-priority request from the target of arbitration in the arbitration processing when the low-priority request is a request realized by controlling the brake, when the plurality of requests include a low-priority request in which a low-priority flag indicating that a priority is lower than another request is set to ON.

2. The management apparatus according to claim 1, wherein the processing circuit is configured to not exclude, when the low-priority request included in the plurality of requests is the request realized without the control of the brake and is the upper limit system request, the low-priority request from the target of arbitration in the arbitration processing.

3. The management apparatus according to claim 2, wherein the processing circuit is configured to receive a plurality of requests including the low-priority request that is the request realized by controlling the brake and that is the upper limit system request from the applications and execute, when a requested value of the low-priority request is not selected as the second arbitration value in the arbitration processing, the arbitration processing by considering the requested value of the low-priority request as a value having a magnitude equivalent to an acceleration rate at a time of engine braking while the low-priority request is the request realized by controlling the brake from the arbitration processing onward.

4. The management apparatus according to claim 1, wherein the processing circuit is configured to receive a plurality of requests including the low-priority request that is the request realized by controlling the brake and that is the lower limit system request from the applications and exclude, when a requested value of the low-priority request is not selected as the second arbitration value in the arbitration processing, the low-priority request from the target of arbitration in the arbitration processing from the arbitration processing onward.

5. The management apparatus according to claim 4, further comprising a storage apparatus configured to store the low-priority request excluded from the target of arbitration in the arbitration processing in the storage apparatus, wherein the processing circuit is configured to exclude the stored low-priority request from the target of arbitration in the arbitration processing from the arbitration processing onward.
